(19) United States
(12) Patent Application Publication
(10) Pub. No.: US 2026/0189861 A1
(43) Pub. Date: Jul. 2, 2026

(54) SELF-LEARNING HEARING DEVICE

(71) Applicant: Starkey Laboratories, Inc., Eden Prairie, MN (US)

(72) Inventor: Achintya Kumar Bhowmik, Saratoga, CA (US)

(21) Appl. No.: 19/426,838

(22) Filed: Dec. 19, 2025

Related U.S. Application Data
(60) Provisional application No. 63/740,592, filed on Dec. 31, 2024.

(51) Int. Cl. H04R 25/00

(52) U.S. Cl. CPC H04R 25/507; H04R 25/43; H04R 2225/43; H04R 2460/07

(57) ABSTRACT

Self-learning hearing device may enhance audio input based on an adaptive model. The adaptive, or changeable, model may be updatable in response to, among other things, user settings adjustments. For example, when a user makes a settings adjustment, the context surrounding, or corresponding to, the settings adjustment may be used to update the adaptive model.

### RELATED PATENT APPLICATIONS

This application claims the benefit of U.S. Provisional Application No. 63/740,592, filed Dec. 31, 2024, the disclosure of which is incorporated by reference herein in its entirety.

### SUMMARY

The present disclosure relates to a self-learning hearing device, and more specifically, systems, devices, and methods to enhance audio input based on an adaptive model where the adaptive, or changeable, model is updatable in response to, among other things, user settings adjustments. A self-learning hearing device, or aid, may be described as an advanced device that automatically adapts to the user's unique listening preferences and environments through continuous learning and optimization. Further, it may be described that the illustrative systems, devices, and methods may be configured to leverage, or utilize, artificial intelligence (AI) and machine learning (ML) algorithms to improve an adaptive model over time thereby providing a personalized auditory experience that enhances the user's quality of life.

Hearing devices, or aids, may deploy, or utilize, onboard AI processing in the form of deep neural networks (DNN) and other machine learning algorithms. These DNNs are trained with audio data in the lab and iteratively optimized based on performance evaluations to minimize their errors, i.e., deviations from target results. Once the optimizations are complete, the models are uploaded into the hearing devices in the form of firmware or software, and their parameters are not allowed to change in the field. Such DNNs or similar models utilized in hearing devices may be referred to as “static models,” as such DNNs or similar models are not adapted, or updated, based on input or behavior provided by the individual users wearing such hearing devices and are typically not adapted, or updated, frequently. For example, and moreover, static models may not be trained based on data (e.g., input, audio input signals, etc.) from an individual user, and instead, the static models may be trained based on example data from a population of users. Further, for example and moreover, static models may only be updated on the order of multiple months (e.g., every 6 months, every 12 months, etc.). Still further, the same static models—not personalized for an individual user—may be utilized by groups of users, which may be updated in clinic or via a downloadable update.

In contrast, the adaptive models (e.g., AI models, machine learning (ML) models, neural networks, etc.) of the illustrative self-learning hearing devices described herein update, or evolve, via continuous parameter optimizations based on user behavior and inputs in real-world use conditions. Thus, for example, an individual user's actual data (e.g., settings adjustments, behaviors, input audio signals measured from one or more microphones of the individual user's hearing device) may be used, or utilized, to update, or evolve, the adaptive model used to enhance an input audio signal resulting in an enhanced audio signal that is tailored to the individual user. Further, for example, the adaptive model of the illustrative self-learning hearing devices may be updated much more frequently than a static model, such as, e.g., every 6 hours, every day, every other day, every week, every two weeks, once a month, etc. As such, the longer users use the illustrative self-learning hearing devices, the better the devices get, or become, in delivering personalized hearing experiences that are specific, or customized, to the users. Furthermore, the adaptive model may be updated using adjustment or historical contexts as will be described further herein, while static models may be not adapted, or not updated, based on the adjustment or historical contexts. Instead, for example, the static models may be updated based on example data from a population of users. Thus, the static models may not be customized, or tailored, to users.

In one or more embodiments, the illustrative self-learning hearing devices (e.g., hearing aids, ear-worn devices, earbuds, etc.) may include one or more adaptive models (e.g., machine learning models, neural networks, etc.) in addition to one or more static models. The adaptive models will continue to train on data received in the field while being worn by the user.

Additionally, as will become apparent from the description of the illustrative embodiments, the illustrative adaptive models may be updated locally on the hearing device and/or in conjunction with a companion external device (e.g., cell phone, smart phone, server, etc.) during use and based on interactions of a single user. It is to be understood that interactions (e.g., settings adjustments) by users may not explicitly be intended to update or change the adaptive models-nonetheless, the illustrative self-learning hearing devices may update, or evolve, adaptive models based on such interactions and contexts associated therewith. Further, the illustrative adaptive models may include or utilize one or more of users' voice detection models, activity classifiers, environment classifiers, comfort in noise vs. speech intelligibility model, etc.

Inputs to the illustrative adaptive models may include, among other things, the following: user inputs or controls such as, e.g., volume changes, program/setting/mode selection, and comfort in noise vs. speech intelligibility control; user activities such as, e.g., walking, social walking, solo walking, exercise, sports, and car riding; and the user's own voice such as, e.g., the volume of the user's own voice and the emotion in the user's voice. Further, it may be described that the inputs to the illustrative adaptive models can be divided into the following two categories: automatic; and manual. The automatic inputs may include, among other things, environment classification, activity classification, location, and speech. The manual inputs may include, among other things, direct user interactions to change parameters and functionality. It may be described that, as direct user interaction decreases over time, it may be determined that the adaptive model has become personalized. In other words, user interaction may be described as being the correction factor of the adaptive models.

It may be further described that the key features of the illustrative systems, devices, and method described herein are adaptive sound processing, user behavior learning, and machine learning integration. More specifically, for example, adaptive sound processing may be described as encompassing, at least, real-time adjustment where the hearing aid continuously monitors the acoustic environment and makes real-time adjustments to optimize sound quality and clarity, noise reduction where advanced algorithms distinguish between speech and background noise, reducing unwanted sounds to improve speech intelligibility, and feedback management where the hearing device automatically detects and eliminates feedback to prevent whistling sounds. Further, more specifically, for example, user behavior learning may be described as encompassing, at least, environmental recognition where the hearing device may identify various listening environments (e.g., quiet rooms, noisy streets, crowded restaurants) and learn the user's preferred settings for each for use in updating an adaptive model, may provide pattern analysis where the hearing device analyzes the user's behavior using the adaptive model, and may analyze manual adjustments (via the control buttons on the device or through the app) to learn preferences and adapt its settings accordingly in various acoustic environments using the adaptive model. Still further, more specifically, for example, machine learning integration may be described as encompassing, at least, data collection where the hearing device collects data on user interactions, environmental conditions, and sound preferences, algorithmic learning where machine learning algorithms process this data to identify patterns and optimize the hearing aid's performance over time, and personalization where the hearing device becomes increasingly personalized, providing tailored auditory experiences based on learned preferences.

During the initial fitting, an audiologist may configure the hearing device based on the user's audiogram and specific hearing needs and the hearing device will begin with a set of default settings optimized for general use. As the user goes about their daily activities, the hearing device may monitor environmental sounds and user interactions and record manual adjustments made by the user (e.g., volume changes, mode switches) and the contexts in which they occur. Machine learning algorithms may analyze the collected data to understand the user's preferences, and the hearing device may automatically adjust its settings in similar future scenarios, reducing manual intervention by the user. In one or more embodiments, users can provide feedback through a mobile app using an external device to help to fine-tune the device's performance. Additionally, the mobile app may allow users to view and adjust learning preferences, ensuring that the hearing device evolves according to their users' desires or optimal hearing performance or experience.

The illustrative systems, devices, and methods may be further described utilizing an adaptive model that is updatable to provide a variety of benefits includes enhanced listening experiences, reduction in manual adjustment, and personalization and comfort. For example, by adapting to the user's unique auditory preferences using the adaptive model, the illustrative hearing device delivers a superior listening experience in various environments. Further, the illustrative hearing device's ability to learn and update the adaptive model may reduce frequent manual adjustments thereby offering greater convenience. Still further, the illustrative hearing device may evolve the adaptive model with the user to ensure a personalized fit and comfort that enhances overall satisfaction. Thus, the illustrative systems, devices, and methods described herein represent a significant advancement in hearing technology by combining sophisticated algorithms and an adaptive model and user-centered design to create a truly adaptive and personalized auditory device. By continuously learning from user behavior and environmental conditions, the illustrative systems, devices, and methods may use the adaptive model to ensure optimal performance and an enhanced listening experience in all aspects of daily life.

One illustrative ear-wearable hearing device includes input apparatus, output apparatus, and a computing apparatus including one or more processors operably coupled to the input apparatus and the output apparatus. The input apparatus includes, among other things, a microphone configured to generate an input audio signal, and the output apparatus includes, among other things, a receiver positionable proximate a user's ear configured to reproduce an enhanced audio signal based on the input audio signal. The computing apparatus is configured to, a least, enhance the input audio signal using at least an adaptive model resulting in the enhanced audio signal, provide the enhanced audio signal to the receiver, allow a user to adjust one or more settings, record an adjustment context including, or comprising, and corresponding to the adjustment of the one or more settings, and update the adaptive model based on the adjustment context.

One illustrative method of ear-wearable hearing device includes, among other things, enhancing an input audio signal from a microphone using at least an adaptive model resulting in an enhanced audio signal, providing the enhanced audio signal to a receiver, allowing a user to adjust one or more settings, recording an adjustment context including, or comprising, and corresponding to the adjustment of the one or more settings, and updating the adaptive model based on the adjustment context.

One illustrative ear-wearable hearing device includes input apparatus, output apparatus, and a computing apparatus including one or more processors operably coupled to the input apparatus and the output apparatus. The input apparatus includes, among other things, a microphone configured to generate an input audio signal, and the output apparatus includes, among other things, a receiver positionable proximate a user's ear configured to reproduce an enhanced audio signal based on the input audio signal. The computing apparatus is configured to, a least, enhance the input audio signal using at least an adaptive model resulting in the enhanced audio signal, provide the enhanced audio signal to the receiver, record a plurality of historical contexts over a time period, each historical context of the plurality of historical contexts associated with a different time and including, or comprising, one or more of setting information, a portion of the input audio signal, movement information, and activity classification at the time of recording, allow the user to indicate effectiveness related to the enhancement of the input audio signal using at least the adaptive model resulting in the enhanced audio signal within the time period, and update the adaptive model based on at least one of the plurality of historical contexts in response to the indication of enhancement effectiveness.

One illustrative method of ear-wearable hearing device includes, among other things, enhancing an input audio signal from a microphone using at least an adaptive model resulting in an enhanced audio signal, providing the enhanced audio signal to a receiver, allowing a user to adjust one or more settings, recording a plurality of historical contexts over a time period, each historical context of the plurality of historical contexts associated with a different time and including, or comprising, one or more of setting information, a portion of the input audio signal, movement information, and activity classification at the time of recording, allowing the user to indicate effectiveness related to the enhancement of the input audio signal using at least the adaptive model resulting in the enhanced audio signal within the time period, and updating the adaptive model based on at least one of the plurality of historical contexts in response to the indication of enhancement effectiveness.

The above summary is not intended to describe each embodiment or every implementation of the present disclosure. A more complete understanding will become apparent and appreciated by referring to the following detailed description and claims taken in conjunction with the accompanying drawings.

### BRIEF DESCRIPTION OF DRAWINGS

FIG. 1 is diagrammatic view of an illustrative system including, among other things, an ear-wearable hearing device.

FIG. 2 is an illustrative method of updating an adaptive model in response to user settings adjustments using the ear-wearable hearing device of FIG. 1

FIG. 3 are diagrams showing multiple neural networks usable in the ear-wearable hearing device of FIG. 1

FIG. 4 is a diagram of a recurrent neural network usable in the ear-wearable hearing device of FIG. 1.

FIG. 5 is another illustrative method of updating an adaptive model in response to user settings adjustments using the ear-wearable hearing device and an additional device, such as the user interface device or server, of FIG. 1.

FIG. 6 is another illustrative method of updating an adaptive model in response to user indications of effectiveness adjustment using at least the ear-wearable hearing device of FIG. 1.

### DETAILED DESCRIPTION

In the following detailed description of illustrative embodiments, reference is made to the accompanying figures of the drawing which form a part hereof, and in which are shown, by way of illustration, specific embodiments which may be practiced. It is to be understood that other embodiments may be utilized, and structural changes may be made without departing from (e.g., still falling within) the scope of the disclosure presented hereby.

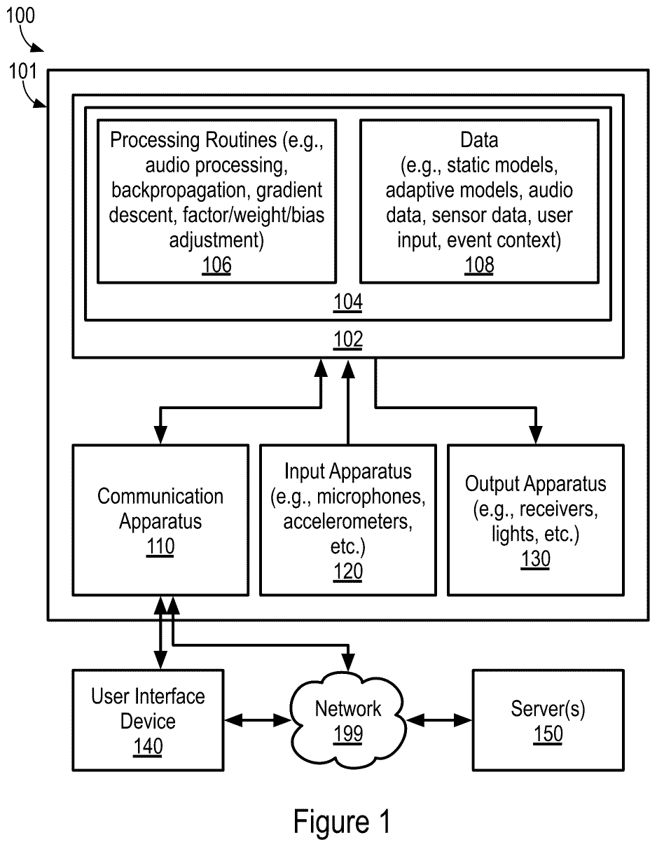

Illustrative systems, devices, and methods shall be described with reference to FIGS. 1-6. It will be apparent to one skilled in the art that elements or processes from one embodiment may be used in combination with elements or processes of the other embodiments, and that the possible embodiments of such systems, devices, and methods using combinations of features set forth herein is not limited to the specific embodiments shown in the Figures and/or described herein. Further, it will be recognized that the embodiments described herein may include many elements that are not necessarily shown to scale. Still further, it will be recognized that timing of the processes and the size and shape of various elements herein may be modified but still fall within the scope of the present disclosure, although certain timings, one or more shapes and/or sizes, or types of elements, may be advantageous over others.

An illustrative system 100 including an ear-wearable hearing device 101, a user interface device 140, and one or more servers 150 is depicted diagrammatically in FIG. 1. The illustrative system 100 may be configured to execute or perform the illustrative methods, processes, and algorithms described herein to provide and update adaptive models, such as neural networks, to enhance an input audio signal resulting in an enhanced audio signal delivered to a user of the ear-wearable hearing device 101.

The ear-wearable hearing device 101 may be described as an ear-worn or ear-level electronic device. Throughout this disclosure, reference is made to a “hearing device” or “ear-wearable hearing device,” which are used interchangeably and understood to refer to a system comprising a single left ear device, a single right ear device, or a combination of a left ear device and a right ear device. Such an ear-wearable hearing device 101 may include cochlear implants and bone conduction devices, without departing from the scope of this disclosure. Further, the term ear-wearable hearing device 101 of the present disclosure refers to a wide variety of ear-level electronic devices that can aid a person with impaired hearing and/or can produce processed sound for persons with normal hearing. For example, the ear-wearable hearing device 101 may also be referred to herein as a hearing aid, wearable earphones, ear monitors, earbuds, a hearing instrument, and a hearing assistance device. Additionally, the ear-wearable hearing device 101 includes, but is not limited to, behind-the-ear (BTE) devices, in-the-ear (ITE) devices, in-the-canal (ITC) devices, invisible-in-canal (IIC) devices, receiver-in-canal (RIC) devices, receiver-in-the-ear (RITE) devices, completely-in-the-canal (CIC) type hearing devices, or some combination thereof.

The ear-wearable hearing device 101 typically includes an enclosure, such as a housing or shell, within which internal components are disposed. Many of the internal components of the hearing device 101 are depicted in FIG. 1 so as to provide a framework for the illustrative functionality (e.g., methods, processes, algorithms, etc.) described herein. The diagram depicted in the FIG. 1 is intended to demonstrate the subject matter, but not in a limited, exhaustive, or exclusive sense.

The hearing device 101 may include, among other things, a processing apparatus 102, a communication apparatus 110, an input apparatus 120, and an output apparatus 130. The processing apparatus 102 is operably coupled to each of the communication apparatus 110, the input apparatus 120, and the output apparatus 130 to provide, at least, the basic functionality of receiving an input audio signal, enhancing the input audio signal, and outputting the enhanced audio signal to a user as well as the illustrative methods, processes, and algorithms described herein.

Although not depicted diagrammatically, it is to be understood that the hearing device 101 further includes any one or more components to provide such basic functionality such as, e.g., but not limited to a power source, a power management circuitry, a charging circuitry, etc. The power source can be a conventional battery, a rechargeable battery (e.g., a lithium-ion battery), or a power source comprising a supercapacitor. Further, the power source may be operably coupled to the power management circuitry for supplying power to various components of the ear-wearable hearing device 101. Further, the power source may be operatively coupled to charging circuitry, and the charging circuitry may be electrically coupled to charging contacts on the housing, which may be configured to electrically couple to corresponding charging contacts of a charging unit when the ear-wearable hearing device 101 is placed in the charging unit.

The processing apparatus 102 may generally include any hardware and software so as to be able to perform or execute the illustrative methods, processes, and algorithms described herein. The processing apparatus 102 may be operably coupled to each of the communication apparatus 110, input apparatus 120, and output apparatus 130 so as to be able to receive and transmit data therebetween. For example, analog or digital connections (e.g., using a data bus, etc.) may be made between the processing apparatus 102 and each of the communication apparatus 110, input apparatus 120, and output apparatus 130.

In one embodiment, the processing apparatus 102 includes one or more processors at least configured to enhance an input audio signal using at least an adaptive neural network resulting in an enhanced audio signal. The processing apparatus 102 may include any one or more microprocessors, multi-core processors, digital signal processors (DSP), application-specific integrated circuits (ASIC), field programmable gate arrays (FPGA), complex programmable logic devices (CPLD), neural processing units (NPU) (e.g., deep learning processors, neural network hardware accelerators, artificial intelligence (AI) accelerators, etc.), microcontrollers, general-purpose computers, special-purpose computers, hardware controllers, software controllers, or any other equivalent integrated or discrete logic circuitry, as well as any combinations of such components, processing devices, or other devices. The term “processing apparatus,” “processor,” or “processing circuitry” may generally refer to any of the foregoing logic circuitry, alone or in combination with other logic circuitry, or any other equivalent circuitry.

It is also to be understood that the processing apparatus 102 may include neural processing functionality operably coupled thereto or incorporated therein. The neural processing functionality may be described as including, among other things, hardware designed to accelerate artificial intelligence and machine learning applications, including artificial neural networks, such as, for example, NPUs, deep learning processors, neural network hardware accelerators, and AI accelerators. In at least one embodiment, the processing apparatus 102 includes neural processing functionality and hardware incorporated therein. In at least one embodiment, the processing apparatus 102 includes a DSP that incorporates a neural network accelerator. In other words, the neural network accelerator may be on, or integrated within, the DSP chip. In at least one embodiment, the illustrative hearing device 101 are utilizing processing apparatus 102 that includes a DSP that incorporates a neural network accelerator that may be run, or executed, continuously and have a battery life of greater than or equal to 10 hours, greater than or equal to 20 hours, greater than or equal to 30 hours, greater than or equal to 40 hours, or greater than or equal to 50 hours. The battery life of the illustrative hearing device 101 utilizing processing apparatus 102 that includes a DSP that incorporates a neural network accelerator may exceed, or be greater, than the battery life of hearing devices utilizing neural networks that run, or execute, on chips or integrated circuits that are not incorporated in a DSP. Thus, the illustrative hearing device 101 utilizing processing apparatus 102 that includes a DSP that incorporates a neural network accelerator may be recharged less frequently that other hearing devices.

Additionally, it is to be understood that the processing apparatus 102 may include audio processing functionality (e.g., circuits, electronics, discrete semiconductor devices, linear or non-linear electronic devices, filters, etc.) operably coupled thereto or incorporated therein. The audio processing functionality includes audio signal processing circuitry such as, for example, analog front-ends, analog-to-digital converters, digital-to-analog converters, DSPs, various analog and digital filters, circuits, discrete semiconductor devices, and linear or non-linear electronic devices.

Further, the processing apparatus 102 includes data storage 104. The data storage 104 can include or be operatively coupled to main memory, such as RAM (e.g., DRAM, SRAM) and non-volatile, or persistent, memory, such as ROM, EPROM, EEPROM or flash memory. In other words, when implemented in software, the functionality ascribed to the systems, devices and methods described in this disclosure may be embodied as instructions on a computer-readable medium such as RAM, ROM, NVRAM, EEPROM, FLASH memory, magnetic data storage media, optical data storage media, or the like. The instructions may be executed by one or more processors of the processing apparatus 102 to support one or more aspects of the functionality described in this disclosure. As will be described in detail herein, the non-volatile memory may be configured to at least facilitate enhancement of an input audio signal using at least an adaptive neural network resulting in an enhanced audio signal and adapting, or updating, the adaptive neural network based on recorded contexts.

The data storage 104 allows for access to processing programs or routines 106 and one or more other types of data 108 that may be employed to carry out the illustrative methods, processes, and algorithms described herein. For example, processing programs or routines 106 may include programs or routines for performing signal processing algorithms, data processing algorithms, artificial intelligence, large language model training, model training, neural network training, neural network bias adjustment, neural network weight adjustment, neural network error evaluation include gradient decent and back propagation, neural network transformers, comparison algorithms, computational mathematics, matrix mathematics, compression algorithms (e.g., data compression algorithms), vector mathematics, or any other processing required to implement one or more embodiments as described herein. Program code and/or logic described herein may be applied to input data to perform functionality described herein and generate desired output information. The output information may be applied as input to one or more other devices and/or processes as described herein or as would be applied in a known fashion.

The data 108 may include, for example, static and adaptive models (e.g., AI models, machine learning (ML) models, neural networks, etc.), audio input data, enhanced audio output data, sensor data (e.g., temperature data, 2-axis or 3-axis acceleration or accelerometer data, heart rate data, body temperature data, location data, positioning data, posture data, activity classification data, environmental data, etc.), user input (e.g., button selections or presses, voice input, gesture input, input via external device such as user interface device 140), adjustment contexts or snapshots, historical contexts or snapshots, settings (e.g., volume, mode, activity profile, etc.), time periods, variables, thresholds, results from one or more processing programs, methods, processes, routines, and algorithms employed according to the disclosure herein, or any other data that may be necessary for carrying out the one or more methods, processes, and algorithms described herein.

The programs used to implement the processes described herein may be provided using any programmable language, for example, a high-level procedural and/or object orientated programming language that is suitable for communicating with a computer system. Any such programs may, for example, be stored on any suitable device, for example, a storage media, readable by a general or special purpose program, computer or a processor apparatus for configuring and operating the computer when the suitable device is read for performing the procedures described herein. In other words, at least in one embodiment, the ear-wearable hearing device 101 including the processing apparatus 102 may be implemented using a computer readable storage medium, configured with a computer program, where the storage medium so configured causes the processing apparatus to operate in a specific and predefined manner to perform functions described herein. The exact configuration of the processing apparatus 102 is not limiting and essentially any device capable of providing suitable computing capabilities and control capabilities (e.g., processing audio data, adapting or updating adaptive models, recording contexts, receiving input, outputting enhanced audio signals, etc.) may be used.

As described herein, a digital file may be any medium (e.g., volatile or non-volatile memory, a memory card, a magnetic storage medium such as a hard disk, a CD-ROM, a punch card, and/or magnetic recordable tape) containing digital bits (e.g., encoded in binary, and/or trinary) that may be readable and/or writeable by processing apparatus 102 described herein. Also, as described herein, a file in user-readable format may be any representation of data (e.g., ASCII text, binary numbers, hexadecimal numbers, decimal numbers, audio, and/or graphical) presentable on any medium (e.g., paper, a display, and/or sound waves) readable and/or understandable by a user.

In view of the above, it will be readily apparent that the functionality as described in one or more embodiments according to the present disclosure may be implemented in any manner as would be known to one skilled in the art. As such, the computer language, the computer system, or any other software/hardware which is to be used to implement the processes described herein shall not be limiting on the scope of the systems, processes or programs (e.g., the functionality provided by such systems, processes, and/or programs) described herein.

While the processing apparatus 102 is described herein, it is be understood that the methods, processes, and algorithms described herein, may be implemented, at least in part, in hardware, software, firmware, or any combination thereof. Such hardware, software, and/or firmware may be implemented within the same device or within separate devices to support the various operations and functions described in this disclosure. In addition, any of the described components may be implemented together or separately as discrete but interoperable logic devices. Depiction of different features, for example, using block diagrams, is intended to highlight different functional aspects and does not necessarily imply that such features must be realized by separate hardware or software components. Rather, functionality may be performed by separate hardware or software components or integrated within common or separate hardware or software components.

The communication apparatus 110 may generally include any hardware and devices so as to be able to communicate wired or wirelessly with external devices such as the user interface device 140, network 199, and one or more servers 150 as graphically indicated using double-sided arrowed lines extending therebetween. For example, the communication apparatus 110 may include one or more antenna configured to transmit wired signals to and to receive wireless signals from one or more external devices. In one embodiment, the one or more antennas may send, or transmit, and receive signals using various wireless protocols. For example, the communication apparatus 110 can include one or more radios that conform to an IEEE 802.11 (e.g., WiFi®) or Bluetooth® (e.g., BLE, Bluetooth® 4. 2, 5.0, 5.1, 5.2 or later) specification, for example. In addition, or alternatively, the communication apparatus 110 can include a near-field magnetic induction (NFMI) sensor (e.g., an NFMI transceiver coupled to a magnetic antenna) for effecting short-range communications (e.g., ear-to-ear communications, ear-to-kiosk communications). Still further, for example, the communication apparatus 110 may include one or more hardware ports configured to transmit wired signals to and receive wired signals from one or more external devices. In one embodiment, the one or more hardware ports may be configured to electrically couple to corresponding hardware ports of a charging unit when the ear-wearable hearing device 101 is placed in the charging unit. For instance, a serial data connection, ethernet data, etc. connection may be established using one or more hardware ports while the ear-wearable hearing device 101 is charging.

As noted herein, the external devices may include a user interface device 140 and one or more servers 150. The user interface device 140 may be a computing device that includes a user interface operable for a user to be able to interact therewith. The user interface device 140 may include similarly structured processing apparatus described herein with respect to the ear-wearable hearing device 101 (e.g., processing apparatus, data storage, etc.), and as such, will not be described further herein. Nonetheless, in one or more embodiments, the processing and data storage capabilities and the power source of the user interface device 140 may exceed, or be greater that, the processing and data storage capabilities and the power source of the ear-wearable hearing device 101, and thus, the user interface device 140 may be utilized by the illustrative methods, processes, and algorithms described herein to offload some processing, data storage, and power consumption from the processing apparatus 102 of the ear-wearable hearing device 101. For example, in at least one embodiment as will be described further herein, the user interface device 140 may update, or adapt, the adaptive neural network based one or more contexts received from the ear-wearable hearing device 101.

Additionally, as will be described further herein, the user interface device 140 may be used by a user to adjust one or more settings of the ear-wearable hearing device 101. For example, the user interface device 140 may present one or more settings (e.g., a plurality of different settings) of the ear-wearable hearing device 101 on a display, a user may select and adjust the presented one or more settings, and the user interface device 140 may communicate with the ear-wearable hearing device 101 to make such adjustments on the ear-wearable hearing device 101 itself. For instance, if a user desires a volume increase of the enhanced audio signal output by the output apparatus 130, the user may increase a volume setting on the user interface device 140, the user interface device 140 may communicate the increased volume setting to the ear-wearable hearing device 101, and in turn, the ear-wearable hearing device 101 may increase the enhanced audio signal output delivered by the output apparatus 130.

The user interface device 140 may further be configured to communicate with additional external devices such as, for example, the one or more servers 150 via the network 199 (e.g., the internet) to transmit or to receive data and processing routines or programs. For example, the user interface device 140 may utilize an application, or app, configured to work with the ear-wearable hearing device 101, and the application may be updated from the one or more servers 150 (e.g., a new, updated versions of the application may be downloaded from the one or more servers 150 replacing the older version of the application, various data or processing routines used by the application may be downloaded from the one or more servers 150 for use by the application, etc.).

Further, for example, each of the one or more servers 150 may be a computing device that includes similarly structured processing apparatus described herein with respect to the ear-wearable hearing device 101 (e.g., processing apparatus, data storage, etc.), and as such, will not be described further herein. Nonetheless, in one or more embodiments, the processing and data storage capabilities and the power source of the one or more servers 150 may exceed, or be greater than, the processing and data storage capabilities and the power source of the ear-wearable hearing device 101 and the user interface device 140, and thus, the one or more servers 150 may be utilized by the illustrative methods, processes, and algorithms described herein to offload some processing and data storage and power consumption from the processing apparatus 102 of the ear-wearable hearing device 101 and the user interface device 140. For example, in at least one embodiment as will be described further herein, one or both of the ear-wearable hearing device 101 and the user interface device 140 may upload one or more contexts to the one or more servers 150, and the one or more servers 150 may update, or adapt, the adaptive neural network based one or more contexts received from one or both of the ear-wearable hearing device 101 and the user interface device 140. Further, the communication apparatus 110 of the ear-wearable hearing device 101 may communicate with the one or more servers 150 indirectly through the user interface device 140 or directly through the network 199.

As described herein, the ear-wearable hearing device 101 further includes input apparatus 120 and output apparatus 130, each operably coupled to the processing apparatus 102 so as to be able to receive and transmit data therebetween. In brief, the input apparatus 120 and the output apparatus 130 may include any devices, circuits, electronics, and apparatus configured to provide at least the basic functionality of hearing device 101, which includes monitoring, or generating, an input audio signal and providing such input audio signal to the processing apparatus 102 to enhance the input audio signal resulting in an enhanced audio signal to be outputted using the output apparatus 130.

For example, the input apparatus 120 includes at least a microphone arrangement operably coupled to the processing apparatus 102 to monitor, or sense, audio and generate an audio input signal and provide such audio input signal to the processing apparatus 102 and the output apparatus 130 includes at least a receiver (e.g., speaker) operably coupled to the processing apparatus 102 to receive an enhanced audio signal and generate and deliver audio to a user using the enhanced audio signal. The microphone arrangement can include one or more discrete microphones or a microphone array(s) (e.g., configured for microphone array beamforming). Each of the microphones of the microphone arrangement can be situated at different locations of a housing of the ear-wearable hearing device 101. It is understood that the term microphone used herein can refer to a single microphone or multiple microphones unless specified otherwise. A receiver of the output apparatus 130 may be positionable proximate a user's ear configured to reproduce an enhanced audio signal based on the input audio signal thereby delivering the enhanced audio to the user. It is to be understood that the receiver being proximate a user's ear may mean that the receiver is configured in any of variety of configurations with varying degrees of proximity to the user's ear as long as the receiver is able to effectively deliver the enhanced audio to the user's ear. For example, in some embodiments, the receiver or components or portions thereof may be located in the user's ear canal. Further, for example, in some embodiments, the receiver or components or portions thereof is disposed in the housing worn behind the ear and sound is delivered from the receiver to the ear canal via a tube.

The input apparatus 120 may further include any devices, circuits, electronics, and apparatus configured to allow a user to provide input to the ear-wearable hearing device 101 to, for example, adjust one of more settings of the hearing device 101, turn on the hearing device 101, and turn off the hearing device 101. For example, the input apparatus 120 may include manually-actuatable buttons and/or switches (e.g., mechanical, capacitive, and/or optical switches). The input apparatus 120 may further or alternatively include a voice recognition interface and natural language processing configured to facilitate user control of the ear-wearable hearing device 101 via voice commands. The voice recognition interface may be configured to discriminate between vocal sounds produced from the user of the hearing device 101 (e.g., “own voice” recognition via an acoustic template developed for the wearer) and vocal sounds produced from other people in the vicinity of the hearing device 101. The user interface may further include or alternatively include a gesture detection interface configured to facilitate user control of the hearing device 101 via gestures (e.g., non-contacting hand and/or finger gestures made in proximity to the hearing device 101). One or more of the manually-actuatable buttons and/or switches, voice recognition interface, and the gesture detection interface may be configured to allow a user to adjust one of more settings of the hearing device 101, turn on the hearing device 101, and turn off the hearing device 101. For instance, the ear-wearable hearing device 101 may include manually-actuatable buttons to adjust, or more specifically, increase or decrease, the volume of the enhanced audio signal output by the output apparatus 130. Such adjustments, as will be described further herein, may be used by the illustrative methods, processes, and algorithms to initiate, or trigger, an event or situation that are can be used to adapt, or train, the adaptive model used to enhance an input audio signal resulting in an enhanced audio signal. For example, an adjustment to a setting (such as, e.g., a volume increase or decrease) may indicate that the ear-wearable hearing device 101 may not be providing the most effective or optimal enhanced audio to the user, and thus, the adjustment to the setting may be indicative of an event or situation that the adaptive model may address or handle better in the future to provide more effective or optimal enhanced audio to the user. As will be described further herein, the illustrative methods, processes, and algorithms will utilize the context (e.g., data from the input apparatus, etc.) of the event or situation to adapt, update, or train the adaptive model to provide more effective or optimal enhanced audio to the user for such event or situation in the future.

Further, as described herein, a user may utilize the user interface device 140 to provide input to the ear-wearable hearing device 101. For example, a user may use the user interface device 140 to adjust one or more settings of the ear-wearable hearing device 101. Such settings adjustments using the user interface device 140 may be handled by the illustrative methods, processes, and algorithms similar or the same way as to the input from the input apparatus 120. For instance, the user interface device 140 may include a touch screen interface to adjust, or more specifically, increase or decrease, the volume of the enhanced audio signal output by the output apparatus 130. Such adjustments using the user interface device 140, as will be described further herein, may be used by the illustrative methods, processes, and algorithms to initiate, or trigger, an event or situation that are can be used to adapt, or train, the adaptive model used to enhance an input audio signal resulting in an enhanced audio signal.

The input apparatus 120 may further include any devices, circuits, electronics, and apparatus configured to provide input to the processing apparatus 102 that may be useful to enhance an input audio signal resulting in an enhanced audio signal. In one or more embodiments as described herein, the input apparatus 120 may include any one or more sensors that can provide additional context for use in updating, or training, an adaptive model used to enhance an input audio signal and then may be used by the adaptive model to enhance the input audio signal.

For example, the input apparatus 120 may include a motion sensor (e.g., 2-axis or 3-axis acceleration data) that may provide motion data (e.g., acceleration data) as additional context to a situation or event that the adaptive model can learn, or be updated, to account for or address to result in an enhanced audio signal with minimal or no user intervention. More specifically, and as will be described further herein, a user may adjust the volume of the ear-wearable hearing device 101 due to noise from driving a car; the motion sensor may detect that a user is driving a car and provide that additional context (e.g., that the user was driving car) to be used when training, or updating, the adaptive model to account for or address that situation in the future.

Further, for example, the input apparatus 120 may include a location sensor (e.g., a global positioning sensor, etc.) that may provide location data (e.g., coordinates, specific location, general location, etc.) as additional context to a situation or event that the adaptive model can learn, or be updated, to account for or address to result in an enhanced audio signal with minimal or no user intervention. More specifically, and as will be described further herein, a user may adjust the volume of the ear-wearable hearing device 101 due to being at a specific location, such as, for example, a zoo; the location sensor may detect that a user is at the specific location and provide that additional context (e.g., that the user is at the zoo) to be used when training, or updating, the adaptive model to account for or address that situation in the future.

Moreover, any of the input apparatus including, for example, the microphone, the motion sensor, and the location sensor may be used for activity classification. For example, the ear-wearable hearing device 101 may be configured to determine the activity that a user is undergoing at a given time based on the input data provided by each of the input apparatus 120. For instance, it may be determined that a user is walking, exercising, playing a sport, riding in a car, etc. based on data received from one or more of the input apparatus 120. In other words, each of the input apparatus may be used by themselves or in conjunction with other input apparatus 120 to determine the activity a user is undergoing to provide an activity classification. The activity classification may be used, or utilized, as additional context to a situation or event that the adaptive model can learn, or be updated, to account for or address to result in an enhanced audio signal with minimal or no user intervention.

It is to be understood that the inputs and input apparatus described herein are only examples, and additional inputs and additional input apparatus are considered by the present disclosure. For instance, other inputs provided by input apparatus 120 may include environmental temperature, body temperature, heart rate data, posture data, body oxygen saturation, etc.

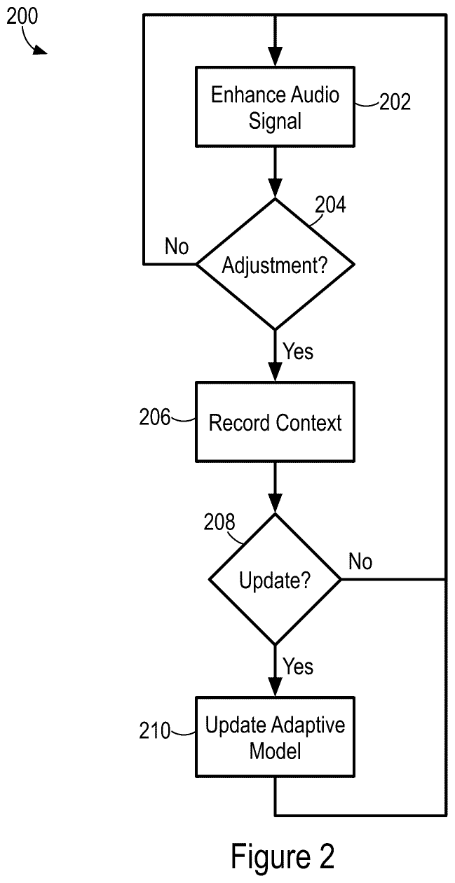

The illustrative systems, devices, and methods generally provide an adaptive model, such as an adaptive neural network, that may be updated (e.g., trained, programmed to, etc.) based on one or more contexts surrounding an event or situation initiated by a user. An illustrative method 200 of updating an adaptive model in response to user settings adjustment using, for example, the ear-wearable hearing device of FIG. 1 is depicted in FIG. 2. In this embodiment, the ear-wearable hearing device 101 may utilize an adaptive model, such as a neural network, and more specifically, a deep neural network to enhance 202 an input audio signal resulting in an enhanced audio signal. The adaptive model may be configured to adjust any one or more settings or parameters of the audio processing performed, or executed, by the processing apparatus 102 to enhance the input audio signal based on the data input (e.g., the input audio signal, one or more other inputs into the input apparatus 120, etc.) into the adaptive model.

The method 200 may additionally be monitoring for any user adjustments 204 to the ear-wearable hearing device 101. For example, the adjustments may include volume increases, volume decreases, noise cancellation (e.g., active noise cancellation) enablement or disablement, mode selection, speech enhancement enablement or disablement, speech enhancement increase or decrease, noise suppression enablement or disablement, noise suppression increase or decrease, etc. The mode selection may include selection of modes from television, crowd, restaurant, music, personal, directional, comfort in noise, streaming, etc.

Further, the adjustments 204 may be made by a user using the input apparatus 120 or the user interface device 140. For example, a user may adjust, or change, the mode of the hearing device 101 using a button on a housing of the hearing device 101. Further, for example, a user may adjust, or change, the volume of the hearing device 101 using a touch screen interface on the user interface device 140.

A user may make such adjustments, or changes, 204 in view of the present event or situation for which the user is in. For example, a user may find themselves in a very noisy environment such as a bus station, and thus, the user may adjust one or more settings to decrease the noise such that the user can hear voices better. Conversely, for example, a user may find themselves in a quiet environment such as in the remote outdoors, and thus, the user may adjust one or more settings to increase sounds such that the user can hear the sounds of the quiet environment better. Further, for example, a user may be located in a setting that has, or includes, a reasonable amount of white noise such as an airplane, and the user may adjust one or more settings to reduce the white noise.

As a result, adjustments to one or more settings of the ear-wearable hearing device 101 by a user may indicate that the adaptive model used to enhance the audio signal delivered to the user could be improved. Thus, if an adjustment 204 is made to one or more settings, the method 200 may proceed to recording, or storing, the context of the adjustment 206, which may also be referred to as the adjustment context. Conversely, if no adjustments 204 are made to one or more settings, the method 200 may continue enhancing the audio signal 202 and continue monitoring for an adjustment 204. In one embodiment, the adjustment context may be recorded 206 on the data storage 104 of the ear-wearable hearing device 101. In another embodiment, the adjustment context may be recorded 206 on the data storage of user interface device 140. It is to be understood that the adjustment context may be stored in a data format configured for consumption, or input, by one or more training methods, processes, or algorithms used to train or adapt the adaptive model as will be described further herein. For example, each adjustment context may be stored in a database and associated with a unique time stamp or other identifier such that each adjustment context may be efficiently retrieved.

The recorded adjustment context 206 may include any one or more pieces of information that may be helpful to update (e.g., change, train, program, etc.) the adaptive model to attempt to improve the adaptive model to address, or handle, the situation or event that resulted in the user making the adjustment. Additionally, the one or more pieces of information of the recorded adjustment context 206 may be recorded over a contextual period of time prior to and following the time point at which the adjustment was made. The recorded adjustment context may include information monitored between about 10 seconds and about 120 seconds, and thus, the contextual time period may be between about 10 seconds and about 120 seconds. In one embodiment, the contextual time period may be 30 seconds. In one or more embodiments, the contextual time period may be greater than or equal to 10 seconds, greater than or equal to 15 seconds, greater than or equal to 20 seconds, greater than or equal to 25 seconds, greater than or equal to 30 seconds, greater than or equal to 40 seconds, greater than or equal to 50 seconds, greater than or equal to 60 seconds, greater than or equal to 70 seconds, greater than or equal to 80 seconds, or greater than or equal to 90 seconds and/or less than or equal to 120 seconds, less than or equal to 110 seconds, less than or equal to 100 seconds, less than or equal to 95 seconds, less than or equal to 85 seconds, less than or equal to 75 seconds, less than or equal to 65 seconds, less than or equal to 55 seconds, less than or equal to 45 seconds, or less than or equal to 35 seconds. Further, in one embodiment, the contextual time period may be centered on the settings adjustment—in other words, half the portion of the recorded adjustment context 206 may occur before the adjustment and half the portion of the recorded adjustment context 206 may occur after the adjustment. In other embodiments, the portion of the recorded adjustment context 206 may not be centered on the settings adjustment such that the portion of the recorded adjustment context that occurred before the adjustment may be greater than or less than the portion of the recorded adjustment context that occurred after the adjustment. In this way, as will be described further herein, the adaptive model may be trained using the recorded adjustment context 206 that is proximate, and likely resulted in, a user's adjustment in an attempt to resolve the less optimal hearing configuration of the ear-wearable hearing device 101.

At the outset, for example, the adjustment context may include the adjustment to the one or more settings itself. For example, if the adjustment to the settings was a volume adjustment from 40% to 65%, the adjustment context may include the starting volume (that is 40% in this example), the resulting volume (that is 65% in this example), and the difference between the starting volume and the resulting volume (that is 25% in this example). Further, for example, if the adjustment to the settings was a mode change from first mode such as, e.g., normal audio processing to a second mode such as, e.g., reading mode, the adjustment context may include the first, or initial mode, the second, or new, mode, the initial mode volume, and the resulting volume in second mode. In this way, as will be described further herein, the adaptive model may be trained using the actual adjustment that the user performed, or executed, in an attempt to resolve the less optimal hearing configuration of the ear-wearable hearing device 101.

Furthermore, for example, the recorded adjustment context 206 may include a portion of the input audio signal corresponding to the one or more settings adjustment 204. In other words, the recorded adjustment context 206 may include the input audio signal that, presumably, initiated the user to make the adjustment. The portion of the input audio signal may be between about 10 seconds and about 120 seconds. In one embodiment, the portion of the input audio signal may be, or have a duration of, 30 seconds. In one or more embodiments, the portion of the input audio signal may be, or have a duration of, greater than or equal to 10 seconds, greater than or equal to 15 seconds, greater than or equal to 20 seconds, greater than or equal to 25 seconds, greater than or equal to 30 seconds, greater than or equal to 40 seconds, greater than or equal to 50 seconds, greater than or equal to 60 seconds, greater than or equal to 70 seconds, greater than or equal to 80 seconds, or greater than or equal to 90 seconds and/or less than or equal to 120 seconds, less than or equal to 110 seconds, less than or equal to 100 seconds, less than or equal to 95 seconds, less than or equal to 85 seconds, less than or equal to 75 seconds, less than or equal to 65 seconds, less than or equal to 55 seconds, less than or equal to 45 seconds, or less than or equal to 35 seconds. Additionally, as described herein, the portion of the input audio signal may or may not be “centered on” settings adjustment. In this way, as will be described further herein, the adaptive model may be trained using the actual input audio signal that likely resulted in a user's adjustment in an attempt to resolve the less optimal hearing configuration of the ear-wearable hearing device 101.

Also, for example, the recorded adjustment context 206 may include one or more features (e.g., one feature, two or more features, a plurality of features, etc.) extracted from, or determined based on, the input audio signal corresponding to the one or more setting adjustments 204. In other words, the recorded adjustment context 206 may include one or more features extracted from, or determined based on, the input audio signal that, presumably, initiated the user to make the adjustment. The one or more features extracted from, or determined based on, the input audio signal may include one or more of a broadband sound pressure level (SPL), a frequency divided SPL, a signal-to-noise ratio (SNR), periodicity strength, high-to-low-frequency, energy ratio, spectral slopes in various frequency regions, average spectral slope, overall spectral slope, spectral shape-related features, spectral centroid, omni signal power, directional signal power, energy at a fundamental frequency, etc. Further, each of the one or more features or measurements extracted from, or determined based on, the input audio signal may be recorded on a per sample basis, as averages, as maximums, as minimums, etc.

Further, for example, the recorded adjustment context 206 may include a state or configuration of one or more of the static model, gains, filters, and any other portion of the audio processing path utilized to enhance the input audio signal. In this way, as will be described further herein, the adaptive model may be trained using the actual state of the audio processing of the device 101 that may have resulted in a user's adjustment in an attempt to resolve the less optimal hearing configuration of the ear-wearable hearing device 101.

Still further, for example, the recorded adjustment context 206 may include movement information corresponding to the one or more settings adjustment 204. In other words, the recorded adjustment context 206 may include a user's movement, which may be related to the reason why the user initiated a settings adjustment. In one embodiment, the movement information may include an accelerometer signal or portion thereof. For example, the accelerometer signal may be provided by a 2-axis or 3-axis accelerometer of the input apparatus 120. In this way, as will be described further herein, the adaptive model may be trained using the actual movement that may have resulted in a user's adjustment in an attempt to resolve the less optimal hearing configuration of the ear-wearable hearing device 101.

Still further, for example, the recorded adjustment context 206 may include location information corresponding to the one or more settings adjustments 204. In other words, the recorded adjustment context 206 may include information regarding where a user, or wearer, of the ear-wearable hearing device 101 is located, which also may be related to the reason why the user initiated a settings adjustment. In one embodiment, the location information may include coordinates of the user's location (e.g., latitude and longitude). In one embodiment, the location information may include a vicinity of the user's location.

In one embodiment, the location information may include a place of the user's location as identified on a map such as, for example, a business, school, building, outdoor venue, park, and road (e.g., Target Field in Minneapolis, Minnesota, Carquinez Bridge in Vallejo, California, The National WWII Museum in New Orleans, Louisiana, etc.), each of which may have unique sound and noise characteristics. In this embodiment, coordinates may be provided by a location sensor (e.g., GPS sensor or similar), and the coordinates may then utilize a map to determine what place the user is located. In this way, as will be described further herein, the adaptive model may be trained using one or more of the actual location and place that may have resulted in a user's adjustment in an attempt to resolve the less optimal hearing configuration of the ear-wearable hearing device 101 at the location or place.

Still further, for example, the recorded adjustment context 206 may include an activity classification corresponding to the one or more settings adjustments 204. In this example, one or both of the ear-wearable hearing device 101 and user interface device 140 may include or utilize an activity classification engine to generate classification data that identifies the activities performed by the user based on input data from the input apparatus 120 such as, e.g., motion information, location information, audio input signals, etc. In other words, the activity classification engine may categorize the activities that the user performs. Activity classifications may include, for example running, walking, watching television, sleeping, talking on the telephone, traveling, engaging in conversation, participating in group activities or meetings, exercising, and sitting still. An example of activity classification methods, processes, algorithms, and engines may be found in U.S. Pat. No. 12,081,933 granted on Sep. 3, 2024, which is incorporated herein by reference in its entirety. Thus, the recorded adjustment context 206 may include an activity classification regarding as to what a user, or wearer, of the ear-wearable hearing device 101 was doing at the time of adjustment, which also may be related to the reason why the user initiated a settings adjustment. In this way, as will be described further herein, the adaptive model may be trained using the activity classification that may have resulted in a user's adjustment in an attempt to resolve the less optimal hearing configuration of the ear-wearable hearing device 101.

And still further, for example, the recorded adjustment context 206 may include an environmental classification corresponding to the one or more settings adjustments 204. In this example, one or both of the ear-wearable hearing device 101 and user interface device 140 may include or utilize an environmental classification engine to generate environmental classification data that identifies the acoustic environment, or space, within which the user is located based on input data from the input apparatus 120 such as, e.g., motion information, location information, audio input signals, etc. In other words, the environmental classification engine may categorize the environment where the user made the adjustment to the one or more settings. An example of environmental classification methods, processes, algorithms, and engines may be found in U.S. Pat. App. Pub. No. 2022/0369048 published on Nov. 17, 2022, which is incorporated herein by reference in its entirety. Thus, the recorded adjustment context 206 may include an environmental classification regarding what sort of environment a user, or wearer, of the ear-wearable hearing device 101 was in, or located, at the time of adjustment, which also may be related to the reason why the user initiated a settings adjustment. In this way, as will be described further herein, the adaptive model may be trained using the environmental classification that may have resulted in a user's adjustment in an attempt to resolve the less optimal hearing configuration of the ear-wearable hearing device 101.

Yet still further, for example, the recorded adjustment context 206 may include a speech versus noise classification corresponding to the one or more settings adjustments 204. In this example, one or both of the ear-wearable hearing device 101 and user interface device 140 may include or utilize a speech versus noise classification engine to generate speech versus noise classification data that distinguishes between speech and noise and may provide, for example, a speech presence probability, which can then be used in conjunction with one or both of noise reduction processes and speech enhancement processes. An example of speech versus noise classification methods, processes, algorithms, and engines may be found in U.S. Prov. Pat. App. Ser. No. 63/683,301 filed on Aug. 15, 2024, which is incorporated herein by reference in its entirety. Thus, the recorded adjustment context 206 may include a speech versus noise classification regarding whether the input audio signal includes or does not include speech among a noisy environment, which also may be related to the reason why the user initiated a settings adjustment. In this way, as will be described further herein, the adaptive model may be trained using the speech versus noise classification that may have resulted in a user's adjustment in an attempt to resolve the less optimal hearing configuration of the ear-wearable hearing device 101.

Lastly, the recorded adjustment context 206 may include a loudness of the user's own speech. In this example, one or both of the ear-wearable hearing device 101 and user interface device 140 may track the loudness of the user's own speech, which may be indicative of whether the present audio processing is providing an optimal hearing experience. For instance, a user's own speech becoming louder typically or often indicates a less than optimal hearing experience. In this way, as will be described further herein, the adaptive model may be trained using the loudness of the user's own speech.

After an adjustment context has been recorded or stored 206, the method 200 may determine whether or not to update to the adaptive model 208. If it is determined to update the adaptive model 208, the method 200 may proceed to updating the adaptive model as will be described further herein. If it is not determined to update the adaptive model 208, the method 200 may return to enhancing the audio signal 202 and monitoring for an adjustment 204 so as to record any additional adjustment contexts if, or in response to, further adjustments being made.

Determination to update the adaptive model 208 may be based on a variety of different factors. For example, if the adaptive model is to be updated using the processing apparatus 102 of the ear-wearable hearing device 101, the updating of the adaptive model may be paused until the hearing device 101 is charging the battery as, e.g., updating the adaptive model may consume a substantial amount of power and the processing apparatus 102 may not have the processing power to update the adaptive model and continue to enhance audio for the user at the same time. Thus, in this example, the method 200 will not determine to update 208 the adaptive model until the ear-wearable hearing device 101 is charging (e.g., docked to a docking station, plugged into a charge cord, wirelessly charging, etc.).

Further, for example, determination of whether to update the adaptive model 208 may be based on time. More specifically, the adaptive model may only be updated after an update time period, or threshold amount of time, has transpired since the last update of the adaptive model. In other words, a determination whether the update time period, or threshold amount of time, has expired since the last update of the adaptive model may be made.

In one embodiment, an update time period, or threshold, may be utilized, and if the time that has elapsed since the last update of the adaptive model is not greater than the update time period, then the adaptive model may not be determined to be updated. Conversely, if the time that has elapsed since the last update of the adaptive model is greater than or equal to the update time period, then the adaptive model may be determined to be updated. The update time period may between about 1 hour and about 7 days. In one embodiment, the update time period may be 24 hours. In one or more embodiments, the update time period may be greater than or equal to 1 hour, greater than or equal to 2 hours, greater than or equal to 4 hours, greater than or equal to 6 hours, greater than or equal to 8 hours, greater than or equal to 10 hours, greater than or equal to 12 hours, greater than or equal to 16 hours, greater than or equal to 20 hours, or greater than or equal to 24 hours, and/or less than or equal to 7 days, less than or equal to 5 days, less than or equal to 3 days, less than or equal to 48 hours, less than or equal to 40 hours, less than or equal to 36 hours, less than or equal to 32 hours, less than or equal to 28 hours, less than or equal to 26 hours, less than or equal to 22 hours, less than or equal to 18 hours, or less than or equal to 14 hours. Thus, the illustrative adaptive models may be updated as frequently has multiple times a day.

Still further, for example, determination of whether to update the adaptive model 208 may be based on a number of adjustments. More specifically, the adaptive model may only be updated after a threshold number of adjustments have occurred, and corresponding adjustments contexts recorded, since the last update of the adaptive model. In this way, the adaptive model may not be updated too frequently, e.g., to avoid too little data to train the adaptive model with, to avoid any inconveniences associated with updating the adaptive model, etc.

In one embodiment, a threshold adjustment number may be utilized, and if the number of adjustments that have occurred since the last update of the adaptive model is not greater than the threshold adjustment number, then the adaptive model may not be determined to be updated. Conversely, if the number of adjustments that have occurred since the last update of the adaptive model is greater than or equal to the threshold adjustment number, then the adaptive model may be determined to be updated. The threshold adjustment number may between about 1 and about 12. In one embodiment, the threshold adjustment number may be 4. In one or more embodiments, the threshold adjustment number may be greater than or equal to 1, greater than or equal to 2, greater than or equal to 4, greater than or equal to 6, greater than or equal to 8, or greater than or equal to 10, and/or less than or equal to 12, less than or equal to 11, less than or equal to 9, less than or equal to 7, less than or equal to 5, or less than or equal to 3.

Furthermore, the threshold adjustment number may be evaluated on a per context basis. In other words, the adaptive model may only be updated after multiple adjustments are made by the user within the same setting and/or context. For example, instead of counting the number of adjustments and comparing the number of the adjustments to the threshold adjustment number, the number of contexts that result in one or more adjustments may be counted and compared to the threshold adjustment number. Thus, in this embodiment, the threshold adjustment number may be referred to as a “threshold context number.”

Still further, in other words, the adaptive model may only be updated if multiple adjustments within a setting and/or context indicate a convergence (e.g., a convergence to desired settings or hearing experience, indication that a user has adjusted their settings until reaching their desired settings or hearing experience, indication that a user has adjusted their settings until whatever hearing experience issues have been resolved, etc.). Additionally, if adjustments made, or executed, within a given context are inconsistent or erratic, such adjustments may be disregarded or ignored. In other words, a user may make, or execute, multiple adjustments in view of a particular context to reach, or provide, a desired hearing experience. Some of the multiple adjustments may not result in the desired hearing experience, and in some cases, may result in a worse hearing experience. Thus, the adaptive model may not be updated using such errant adjustments that do not result in the desired hearing experience and/or may result in a worse hearing experience.

It is to be understood that each of variety of different factors may be used in combination or individually to determine whether or not to update the adaptive model 208. Furthermore, some of the factors may be weighted more heavily than others, and some of the factors may be dispositive. For example, determining not to update the adaptive model until the hearing device 101 is charging may dispositive. In other words, whether or not the hearing device 101 is charging may override any other factors that indicate that the adaptive model should be updated.

As described herein, if is determined 208 that the adaptive model be updated based on the one or more recorded contexts, each including and corresponding to an adjustment of one or more settings of the hearing device 101, the method 200 may proceed to updating the adaptive model 210. The adaptive model may may include one or more AI models, machine learning (ML) models, neural networks, or the like. In one embodiment, the adaptive model is an adaptive deep neural network (DNN). In one embodiment, the adaptive model is an adaptive DNN including one or more of a transformer network and a recurrent neural network.

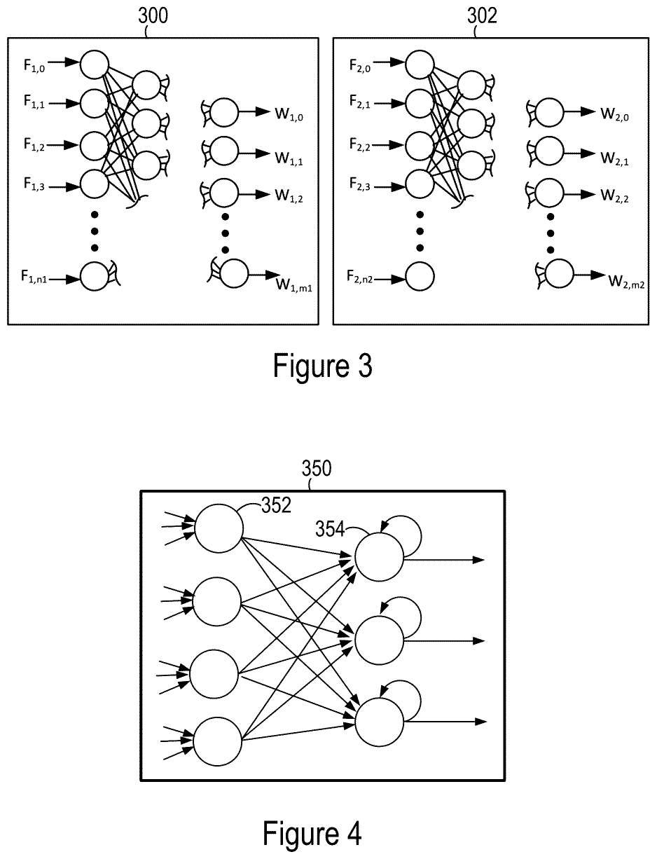

Diagrams of illustrative multiple neural networks that may be used with the illustrative hearing device 101 and illustrative methods, processes, and algorithms described herein are shown in FIG. 3. In this example, two DNNs 300, 302 are shown that may be used for sound enhancement. Each DNN 300, 302 may have a unique input feature vector F1, F2, and output vector W1, W2. The size of these vectors affects the size of the resulting network 300, 302 and also affects any upstream or downstream processing components of the hearing device 101 that are coupled to the networks 300, 302.

The networks 300, 302 may also have other differences that are not reflected in the input and output vectors. For example, the number and type of hidden layers within each neural network 300, 302 may be different. Further, the type of neural networks 300, 302 may also be different, e.g., feedforward, (vanilla) recurrent neural network (RNN), long short-term memory (LSTM), gated recurrent units (GRU), light gated recurrent units (LiGRU), convolutional neural network (CNN), spiking neural networks, etc. These different network types may involve different arrangements of state data in memory, different processing algorithms, etc.

Another type of neural network that may be used by the illustrative hearing device 101 and illustrative methods, processes, and algorithms described herein is an RNN. An illustrative RNN 350 is shown in FIG. 4. In addition to traditional neurons 352 that “fire” when the combination of inputs reaches some criterion, the RNN includes neurons 354 with a memory that takes into account, or considers, previously processed data in addition to the current data being fed through the network. Examples of RNN nodes 354 include LSTM, GRU, and LiGRU nodes may be useful for such tasks as speech recognition.

Another type of DNN that may be used by the illustrative hearing device 101 and illustrative methods and processes described herein is known as a spiking neural network. Spiking neural networks are a type of artificial neural networks that closely mimic the functioning of biological neurons to the extent of replicating communication through the network via spikes once a neuron's threshold is exceeded. Such spiking neural network may incorporate the concept of time into their operating model and are asynchronous in nature.

Regardless of the type of adaptive model utilized, the adaptive model may be updated 210, for example, by training the adaptive model using the one or more recording adjustment contexts. In one embodiment, the one or more recorded adjustment contexts may be included and represent data in the input and output vectors to be used to train the adaptive model. For example, the inputs, or data, of the input vector may include any of the inputs, or data, included in an adjustment context, and the output vector may include one or more of the adjusted settings and how the settings was adjusted also recorded in the adjustment context as well as a portion of the enhanced audio signal following the adjustment. In this way, the adaptive model may be effectively trained to account for the event, or situation, where the user changed one or more settings.

For example, if a user decreases the volume of the hearing device 101 in response to a noisy environment such as supermarket, the recorded adjustment context may include one or more of the following: the identification of the setting that was changed; the volume settings decrease; the initial volume setting; the changed volume setting; the input audio signal portion from the time of the adjustment; location information indicating the coordinates of the supermarket or the supermarket itself; movement information indicating a slow walk through the supermarket; an activity classification of low activity; and an environment classification of a noisy environment. Thus, each of the identification of the setting that was changed, the volume settings decrease, the initial volume setting, the changed volume setting, the input audio signal portion from the time of the adjustment, location information indicating the coordinates of the supermarket or the supermarket itself, movement information indicating a slow walk through the supermarket, the activity classification of low activity, and the environment classification of a noisy environment may be provided as an input vector for training the adaptive model. The output vector for training the adaptive model may include the volume settings decrease, the changed volume setting, and a portion of the enhanced audio signal following the adjustment. In this way, the adaptive model may be trained, or iterated, to be able to receive the data from the input apparatus including the input audio signal and output the enhanced audio signal and/or one more settings adjustments in according with providing an optimal hearing experience.

As described herein with respect to neural networks, weights, biases, and other state data are associated with each the network elements (e.g., sigmoid neurons) defining one or more matrices that represent the “intelligence” of the adaptive model and are determined in a training phase using test data. In one embodiment, the training involves modifying or adjusting weights, biases, and other state data of the matrices when receiving the input vector to achieve the desire output vector. Each of state of the adaptive model may be scored, and the score may be used to adjust state variables of the network (e.g., weights and biases in the neurons) and the process may be repeated until the adaptive model achieves some level of accuracy or other measure of performance. In one or more embodiments, the training may also involve pruning and quantization of the DNN model, which helps reduce the computation resources used in running the model in a hearing device.

Generally, quantization involves using smaller representations of the data used to represent the elements of the neural network. For example, values may be quantized within a −1 to 1 range, with weights quantized to 8-bit values and activations quantized to 16-bit values. Equation (1) below shows a linear quantization according to illustrative embodiments. Custom quantization layers can be created to quantize all weight values during feedforward operation of the network.

$$LinearQuantization ( x , bitwidth ) = Clip ( \frac{round ( x \times {2}^{bitwidth - 1} )}{{2}^{bitwidth - 1}} , - 1 , \frac{{2}^{bitwidth - 1} - 1}{{2}^{bitwidth - 1}} ) \qquad ( 1 )$$

Weights and biases can be pruned using threshold-based pruning that removes lower magnitude weights, e.g., with a magnitude close to zero for both positive and negative numbers. Percentages used in the threshold-based pruning can set to acquire a target weight sparsity during training, which may allow compression of the representation of the weights in storage, as well as reducing the memory footprint and number of computations involved in running the adaptive model. It is to be understood that the training processes provided herein are only example and that multiple different training methods may be used to train the adaptive models described herein. Nonetheless, it is to be understood the adaptive model may be updated 210 by training the adaptive model or performing similar improvements to the adaptive model using any known technique, process, or algorithm. Further, it is to be understood that updating 210 the adaptive model may include generating an updated adaptive model to replace the previous adaptive model used by the hearing device 101. Conversely, it is to be understood that updating 210 the adaptive model does not include merely changing the state, changing the internal state memory (e.g., of a feed-backward neural network), or similar functions of one or both of the static and adaptive model used by a hearing device. In other words, updates of the adaptive model may be a continuation of training of the model specific to the user such that user adjustments provide the expected output to update the adaptive model.

After update of adaptive model 210, the method 200 may return to enhancing the audio signal 202 and monitoring for an adjustment 204 so as to record any additional adjustment contexts if, or in response to, further adjustments being made. Additionally, if the adaptive model has been updated, and a user decides that the adaptive model is not as effective as it was previous to updating, a user may be allowed to return the adaptive model to not being updated (e.g., roll-back to the previous adaptive model).

Further, the hearing device 101 may be paired (e.g., Bluetooth pairing, etc.) with other alternative audio sources such as smart phones, televisions, personal computers, television streamers, remote microphones, or other hearing device accessories to deliver audio signals directly therefrom to the output apparatus 130, e.g., receiver, such that users may have an enhanced listening experience when using such devices. The illustrative systems, methods, and devices may further utilize a user's pairing behavior and adjustment thereof to initiate a recorded adjustment context. In this way, the recorded adjustment context surrounding when a user pairs the hearing device 101 to alternative audio sources may be utilized to update the adaptive model, such that the adaptive model may be able to automatically pair the hearing device 101 to such alternative audio sources when given certain circumstances. For example, the adaptive model may learn, from one or more recorded contexts, the sound of user's television turning, the sound from the television speakers from the television program, the user's location (e.g., a home), the user's posture (e.g., sitting on a sofa), etc. and determine that such context should result in automatic pairing of the hearing device 101 with the television. In other words, a user's pairing behavior may be considered to be an adjustment to one or more settings, and thus, may be used to trigger, or initiate, a recorded adjustment context, which may be used to train the adaptive model. In turn, the adaptive model may learn how to adjust the pairing settings to optimize the user's experience.

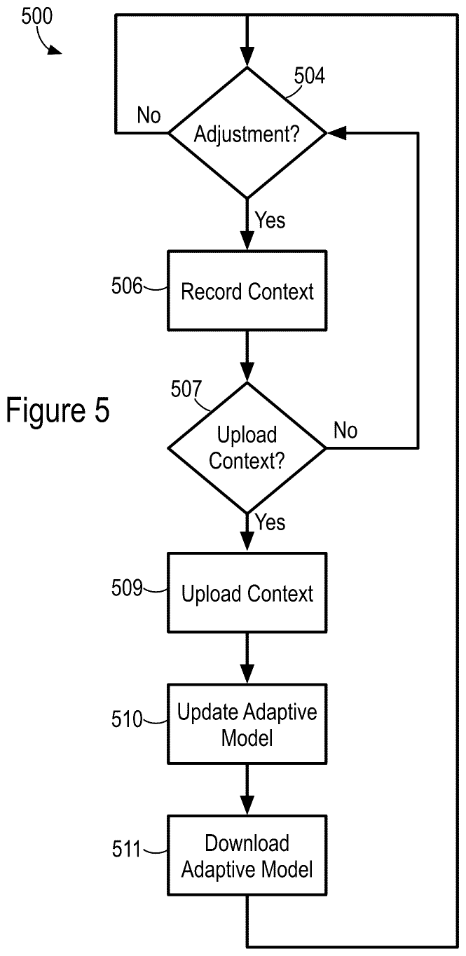

As described herein, the ear-wearable hearing device 101 may work in conjunction with an external device such as one or both of the user interface device 140 and one or more servers 150 to provide an updated adaptive model based on one or more recorded adjustment contexts. Another illustrative method 500 of updating an adaptive model in response to user settings adjustments using the ear-wearable hearing device and an external, or additional, device is shown in FIG. 5. In summary, the method 500 is substantially similar to the method 200 described herein with respect to FIG. 2 except that the recorded adjustment contexts are uploaded to an external device, which performs the adaptive model updating, and then the updated model is downloaded to the hearing device. Additionally, although some processes, such as enhancing audio signal 202 and determining whether to update 208, are omitted from method 500, it is be understood that such processes may be included in method 500 in a similar fashion as in method 200.

The method 500 includes monitoring for any user adjustments 504 to the ear-wearable hearing device 101, which may be made by a user using the input apparatus 120 or the user interface device 140. Next, the method 500 includes recording the adjustment context 506 that corresponds to the user adjustment. Processes 504, 506 may be substantially similar to processes 204, 206 of FIG. 2, and as such, will not be described further herein.

The method 500 further includes determining whether to upload the adjustment context to an external device 507, such as the user interface device 140 or one or more servers 150. Determination to upload the adjustment context to the external device 507 may be based on a variety of different factors similar to the determination to update the adaptive model 208 of method 200 as shown in FIG. 2.

For example, communication of the adjustment context from the ear-wearable hearing device 101 to external device may be computationally expensive and power intensive. Thus, for example, the uploading of the recorded adjustment contexts to an external device may be paused until the hearing device 101 is charging the battery. Thus, in this example, the method 500 will not determine to upload the recorded adjustment context 507 to the external device until the ear-wearable hearing device 101 is charging (e.g., docked to a docking station, plugged into a charge cord, wirelessly charging, etc.).

Further, for example, determination of whether to upload the recorded adjustment contexts 507 may be based on time. More specifically, the recorded adjustment contexts may only be uploaded after an upload time period has transpired since the last upload of the recorded adjustment contexts. The duration of the upload time period may be similar to the duration of the adjustment time period described herein with respect to method 200 of FIG. 2, and as such, will not be described further herein.

Still further, for example, determination of whether to upload the recorded adjustment contexts 507 may be based on a number of adjustments or recorded adjustment contexts. More specifically, the recorded adjustment contexts 507 may only be uploaded after a threshold number of adjustments or recorded adjustment contexts have occurred since the last upload. In this way, uploads may not occur too frequently, e.g., to avoid too little data to train the adaptive model with, to avoid any inconveniences associated with uploading, etc. The number of adjustments or recorded adjustment contexts may be compared to a threshold adjustment number to determine whether to upload the recorded adjustment contexts in a similar fashion as described herein with respect to method 200 of FIG. 2, and as such, will not be described further herein.

If it is not determined to upload the one or more recorded adjustment contexts 507, the method 500 may return to monitoring for more adjustments 506. If it is determined to upload the one or more recorded adjustment contexts 507, the one or more recorded adjustment contexts may be uploaded to the external device 509, e.g., using the communication apparatus 110. Once one or more recorded adjustment contexts are uploaded to the external device, such as the user interface device 140 or the one or more servers 150, the method 500 may proceed to updating the adaptive model 510. The adaptive model and updating thereof 510 may be substantially similar to the adaptive model and updating thereof of process 210 of method 200 of FIG. 2, and as such, will not be described further herein.

After the adaptive model has been updated 510, the method 500 may download the updated adaptive model 511 to the hearing device 101 for use therewith. Thereafter, the method 500 may return to monitoring for adjustments 506.

There may be circumstances where a user had a less optimal hearing configuration or experience with their ear-wearable hearing device 101 but did not make any adjustments near, or proximate, to the time at which the acoustic issues were occurring. However, a user may desire to provide input about such less optimal hearing configuration or experience to improve the adaptive model of the hearing device 101. In other words, a user may want to indicate hearing problems or issues “after-the-fact” and have the hearing device learn from such hearing problems or issues.

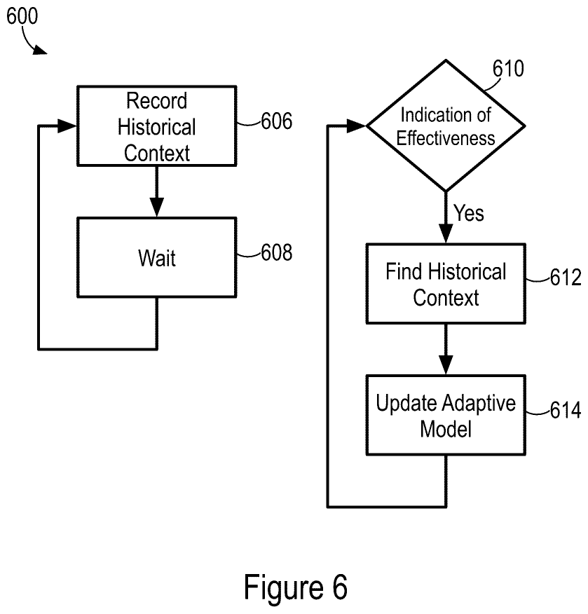

Another illustrative method 600 of updating an adaptive model in response to user indications of effectiveness adjustment using at least the ear-wearable hearing device 101 is depicted in FIG. 6. As shown, since the user will not have made any adjustments to the hearing device 101 during, or near, when the hearing problems or issues were occurring, the method 600 may be described as periodically recording historical contexts or snapshots 602. Recording a historical context 606 may be substantially similar to recording an adjustment context 206 as described herein with respect to method 200 of FIG. 2 but not in response to a user adjustment of one or more settings. In one embodiment, each historical context includes one or more of setting information, a portion of the input audio signal, movement information, and activity classification at the time of recording.

Each historical context 606 may be monitored over a historical time period such as between about 10 seconds and 5 minutes. In one embodiment, historical time period may be 25 seconds. In one or more embodiments, historical time period may be may be greater than or equal to 25 seconds, greater than or equal to 35 seconds, greater than or equal to 45 seconds, greater than or equal to 55 seconds, greater than or equal to 75 seconds, or greater than or equal to 95 seconds, and/or less than or equal to 5 minutes, less than or equal to 4 minutes, less than or equal to 3 minutes, less than or equal to 150 seconds, less than or equal to 120 seconds, less than or equal to 110 seconds, less than or equal to 90 seconds, less than or equal to 85 seconds, or less than or equal to 65 seconds.

After the historical context is recorded 606, another historical context may not be recorded for a periodic time period. Thus, the method 600 may wait 608 for the periodic time period before returning to recording another historical context 606. In this way, it may be described that historical contexts may be recorded at consistent intervals or periodically according to the selected wait time. The periodic time period may be between about 1 minute and about 1 hour. In one embodiment, the periodic time period may be 15 minutes. In one or more embodiments, the periodic time period may be may be greater than or equal to 1 minute, greater than or equal to 2 minutes, greater than or equal to 3 minutes, greater than or equal to 5 minutes, greater than or equal to 10 minutes, or greater than or equal to 20 minutes, and/or less than or equal to 60 minutes, less than or equal to 45 minutes, less than or equal to 30 minutes, less than or equal to 25 minutes, less than or equal to 15 minutes, less than or equal to 12 minutes, less than or equal to 7 minutes, or less than or equal to 4 minutes.

Alternatively, after the historical context is recorded 606, another historical context may not be recorded until a new listening environment (e.g., quiet rooms, noisy streets, crowded restaurants), new user activity, and/or new location is encountered. In other words, another historical context may not be recorded until the hearing device encounters listening environmental changes (acoustic or otherwise). For example, if a user moves riding in a quiet car interior to walking on a noisy street, such change in listening environment, user activity, and/or location may trigger, or initiate, the recordation of an historical context. Further, for example, if a user moves cross-country skiing through a quiet forest to watching television in a cabin, such change in listening environment, user activity, and/or location may trigger, or initiate, the recordation of an historical context.

Thus, a plurality of historical contexts may be recorded over a time period such as, for example, a day or a week. Each of the plurality of historical contexts may be associated with a different time over the time period. For example, if the historical time period is 30 seconds and the periodic time period is 10 minutes, 144 historical contexts, each covering 30 seconds at a different time, may be recorded over a time period of day.

The method 600 further includes monitoring for an indication of effectiveness 610 from a user. The indication of effectiveness may be described as feedback from a user regarding the effectiveness of the hearing device 101 during a time that has already occurred, such as a few hours ago. The user may provide, or enter, the indication of effectiveness to the system 100 in a variety of different ways. For example, the user may utilize a voice recognition feature and natural language processing feature of the hearing device 101 to tell the hearing device 101 about less optimal hearing configurations or experiences that occurred in the past. For instance, a user may say, “Hey hearing aid, I really struggled with wind noise today,” and the user's statement may be recognized and processed to provide, or generate, an indication of effectiveness. Further, the user may utilize a touch screen interface of the user interface device 140 to indicate to the hearing device 101 about less optimal hearing configurations or experiences that occurred in the past.

Upon the receipt of an indication of effectiveness, the method 600 may search for and find the historical context 612 corresponding to the indication of effectiveness. For example, if the user provided the time of day when the less optimal hearing configurations or experiences occurred, then the method 600 may find 612 the historical context corresponding to the provided time such as, for example, the historical context that occurred closest to the provided time. In other words, the historical context may be temporally associated with the user's indication of effectiveness. Further, for example, if the user provided what activity that user was performing when the less optimal hearing configurations or experiences occurred, then the method 600 may find 612 the historical context corresponding to the activity classification corresponding to or closest to the provided activity. Still further, for example, if the user provided what environment or location that the user was located in when the less optimal hearing configurations or experiences occurred, then the method 600 may find 612 the historical context corresponding to the environmental classification or located corresponding to or closest to the provided environment or location.

For instance, if a user was fishing on Poohbah Lake in Ontario, Canada, and the wind was howling causing a less optimal experience with their hearing device, the user could provide an indication of effectiveness hours later by indicating one or more of when, where, or what sort of environment that user was in when the less optimal experience occurred, and the method 600 may find the historical context 612 based on such input.

After the historical context is found 612, the historical context may be provided to be used to update the adaptive model 614. The adaptive model and updating thereof 612 may be substantially similar to the adaptive model and updating thereof of process 210 of method 200 of FIG. 2, and as such, will not be described further herein. After update of adaptive model 612, the method 600 may return to monitoring, or waiting, for another indication of effectiveness from a user 610. Additionally, as processes 606, 608 are shown separate from the processes 610, 612, 614, it is to be understood that processes 606, 608 may run, or be executed, in parallel with processes 610, 612, 614. Thus, the method 600 may continue periodically recording historical contexts 606 while waiting for a user to provide an indication of effectiveness.

### Illustrative Examples

While the present disclosure is not so limited, an appreciation of various aspects of the disclosure will be gained through a discussion of the specific illustrative examples provided below. Various modifications of the illustrative examples, as well as additional examples of the disclosure, will become apparent herein.

Example Ex1: An ear-wearable hearing device comprising:
input apparatus comprising a microphone configured to generate an input audio signal;
output apparatus comprising a receiver positionable proximate a user's ear configured to reproduce an enhanced audio signal based on the input audio signal; and
a computing apparatus comprising one or more processors operably coupled to the input apparatus and the output apparatus, wherein the computing apparatus is configured to:
   enhance the input audio signal using at least an adaptive model resulting in the enhanced audio signal;
   provide the enhanced audio signal to the receiver; allow a user to adjust one or more settings;
   record an adjustment context comprising and corresponding to the adjustment of the one or more settings; and
   update the adaptive model based on the adjustment context.

Example Ex2: A method of ear-wearable hearing device comprising:
enhancing an input audio signal from a microphone using at least an adaptive model resulting in an enhanced audio signal;
providing the enhanced audio signal to a receiver; allowing a user to adjust one or more settings; recording an adjustment context comprising and corresponding to the adjustment of the one or more settings; and
updating the adaptive model based on the adjustment context.

Example Ex3: The device or method as in any one of the preceding Examples, wherein the one or more settings comprises volume.

Example Ex4. The device or metho as in any one of the preceding Examples, wherein the one or more settings comprises mode.

Example Ex5: The device or method as in any one of the preceding Examples, wherein the adjustment context comprises at least one feature of a portion of the input audio signal corresponding to the one or more settings adjustment.

Example Ex6: The device or method as in Example Ex5, wherein the portion of the input audio signal is less than or equal to 120 seconds.

Example Ex7: The device or method as in any one of the preceding Examples, wherein the adjustment context comprises movement information corresponding to the one or more settings adjustment.

Example Ex8: The device or method as in any one of the preceding Examples, wherein the adjustment context comprises location information corresponding to the one or more settings adjustment.

Example Ex9: The device or method as in any one of the preceding Examples, wherein the adjustment context comprises an activity classification, wherein activity classification comprises one or more of walking, exercising, playing a sport, and riding in a car.

Example Ex10: The device or method as in any one of the preceding Examples, wherein adjusting the adaptive model based on the adjustment context comprises adjusting the adaptive model following expiration of an adjustment time period, wherein the adjustment time period is less than or equal to 72 hours.

Example Ex11: The device or method as in any one of Examples Ex1-Ex9, wherein adjusting the adaptive model based on the adjustment context comprises adjusting the adaptive model following expiration of an adjustment time period, wherein the adjustment time period is less than or equal to 24 hours.

Example Ex12: The device or method as in any one of the preceding Examples, wherein updating the adaptive model based on the adjustment context comprises adjusting the adaptive model in response to user initiation.

Example Ex13: The device or method as in any one of the preceding Examples, wherein updating the adaptive model based on the adjustment context comprises updating the adaptive model in response to a selected number of adjustments of one or more settings, wherein the selected number is less than or equal to 10.

Example Ex14: The device or method as in any one of the preceding Examples, wherein updating the adaptive model based on the adjustment context comprises:
uploading the adjustment context an external device, wherein the external device updates the adaptive model based on the uploaded adjustment context; and
receiving the updated adaptive model; replacing the adaptive model with the updated adaptive model.

Example Ex15: The device or method as in any one of the preceding Examples, wherein allowing the user to adjust one or more settings comprises: allowing the user to adjust one or more settings using an external device; and receiving the adjusted one or more settings from the external device.

Example Ex16: The device or method as in any one of Example Ex14 and Example Ex15, wherein the external device is a smartphone.

Example Ex17: The device or method as in Example Ex14, wherein the external device is a server.

Example Ex18: The device or method as in any one of the preceding Examples, wherein enhancing the input audio signal using at least the adaptive model resulting in the enhanced audio signal comprises enhancing the input audio signal using at least the adaptive model and a static model resulting in the enhanced audio signal, wherein the static model in unadjusted based on the adjustment context corresponding to the adjustment of the one or more settings.

Example Ex19: The device or method as in any one of the preceding Examples, wherein the static model comprises a neural network.

Example Ex20: The device or method as in any one of the preceding Examples, wherein the adaptive model comprises a deep neural network.

Example Ex21: The device or method as in any one of the preceding Examples, wherein the computing apparatus is further configured to execute or the method further comprises:
recording a plurality of historical contexts over a time period, each historical context of the plurality of historical contexts associated with a different time and comprising one or more of setting information, a portion of the input audio signal, movement information, and activity classification at the time of recording;
allowing the user to indicate effectiveness related to the enhancement of the input audio signal using at least the adaptive model resulting in the enhanced audio signal within the time period; and
updating the adaptive model based on at least one of the plurality of historical contexts in response to the indication of enhancement effectiveness.

Example Ex22: The device or method as in Example Ex21, wherein recording the plurality of historical contexts over the time period comprises periodically recording the plurality of historical contexts over the time period according to a periodic time period.

Example Ex23: The device or method as in Example Ex22, wherein the periodic time period is less than or equal to 20 minutes.

Example Ex24: The device or method as in Example Ex21, wherein recording the plurality of historical contexts over the time period comprises recording the plurality of historical contexts over the time period in response to a change in listening environment, user activity, or location.

Example Ex25: The device or method as in any one of Examples Ex21-Ex24, wherein updating the adaptive model based on at least one of the plurality of historical contexts in response to the indication of enhancement effectiveness comprises:
identifying at least one historical context of the plurality of historical contexts associated with the indication of effectiveness; and
updating the adaptive model based on the identified at least one historical context and the indication of effectiveness.

Example Ex26: The device or method as in Example Ex25, wherein the identifying at least one historical context of the plurality of historical contexts associated with the indication of effectiveness comprising identifying the at least one historical context of the plurality of historical contexts temporally associated with the indication of effectiveness.

Example Ex27: The device or method as in any one of the preceding Examples, wherein the computing apparatus is further configured to execute or the method further comprises allowing, following update of the adaptive model, the user to return the adaptive model to prior to being updated.

All references and publications cited herein are expressly incorporated herein by reference in their entirety for all purposes, except to the extent any aspect directly contradicts this disclosure.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g., 1 to 5 includes 1, 1.5, 2, 2.75, 3, 3.80, 4, and 5) and any range within that range. Herein, the terms “up to” or “no greater than” a number (e.g., up to 50) includes the number (e.g., 50), and the term “no less than” a number (e.g., no less than 5) includes the number (e.g., 5).

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality (for example, a mobile user device may be operatively coupled to a cellular network transmit data to or receive data therefrom).

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like.

The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

What is claimed is:

1. An ear-wearable hearing device comprising:
input apparatus comprising a microphone configured to generate an input audio signal;
output apparatus comprising a receiver positionable proximate a user's ear configured to reproduce an enhanced audio signal based on the input audio signal; and
a computing apparatus comprising one or more processors operably coupled to the input apparatus and the output apparatus, wherein the computing apparatus is configured to:
enhance the input audio signal using at least an adaptive model resulting in the enhanced audio signal;
provide the enhanced audio signal to the receiver;
allow a user to adjust one or more settings;
record an adjustment context comprising and corresponding to the adjustment of the one or more settings; and
update the adaptive model based on the adjustment context.

2. The device of claim 1, wherein the one or more settings comprises one or more of volume and mode.

3. The device of claim 1, wherein the adjustment context comprises at least one feature of a portion of the input audio signal corresponding to the one or more settings adjustment.

4. The device of claim 3, wherein the portion of the input audio signal is less than or equal to 120 seconds.

5. The device of claim 1, wherein the adjustment context comprises movement information corresponding to the one or more settings adjustment.

6. The device of claim 1, wherein the adjustment context comprises location information corresponding to the one or more settings adjustment.

7. The device of claim 1, wherein the adjustment context comprises an activity classification, wherein activity classification comprises one or more of walking, exercising, playing a sport, and riding in a car.

8. The device of claim 1, wherein adjusting the adaptive model based on the adjustment context comprises adjusting the adaptive model following expiration of an adjustment time period, wherein the adjustment time period is less than or equal to 72 hours.

9. The device of claim 1, wherein updating the adaptive model based on the adjustment context comprises adjusting the adaptive model in response to user initiation.

10. The device of claim 1, wherein updating the adaptive model based on the adjustment context comprises updating the adaptive model in response to a selected number of adjustments of one or more settings, wherein the selected number is less than or equal to 10.

11. The device of claim 1, wherein updating the adaptive model based on the adjustment context comprises:
uploading the adjustment context an external device, wherein the external device updates the adaptive model based on the uploaded adjustment context;
receiving the updated adaptive model; and
replacing the adaptive model with the updated adaptive model.

12. The device of claim 1, wherein allowing the user to adjust one or more settings comprises:
allowing the user to adjust one or more settings using an external device; and
receiving the adjusted one or more settings from the external device.

13. The device of claim 1, wherein enhancing the input audio signal using at least the adaptive model resulting in the enhanced audio signal comprises enhancing the input audio signal using at least the adaptive model and a static model resulting in the enhanced audio signal, wherein the static model in unadjusted based on the adjustment context corresponding to the adjustment of the one or more settings.

14. The device of claim 13, wherein the static model comprises a neural network and the adaptive model comprises a deep neural network.

15. The device of claim 1, wherein the computing apparatus is further configured to:
record a plurality of historical contexts over a time period, each historical context of the plurality of historical contexts associated with a different time and comprising one or more of setting information, a portion of the input audio signal, movement information, and activity classification at the time of recording;
allow the user to indicate effectiveness related to the enhancement of the input audio signal using at least the adaptive model resulting in the enhanced audio signal within the time period; and
update the adaptive model based on at least one of the plurality of historical contexts in response to the indication of enhancement effectiveness.

16. The device of claim 15, wherein recording the plurality of historical contexts over the time period comprises periodically recording the plurality of historical contexts over the time period according to a periodic time period.

17. The device of claim 16, wherein the periodic time period is less than or equal to 20 minutes.

18. The device of claim 15, wherein recording the plurality of historical contexts over the time period comprises recording the plurality of historical contexts over the time period in response to a change in listening environment, user activity, or location.

19. The device of claim 15, wherein updating the adaptive model based on at least one of the plurality of historical contexts in response to the indication of enhancement effectiveness comprises:
identifying at least one historical context of the plurality of historical contexts associated with the indication of effectiveness; and
updating the adaptive model based on the identified at least one historical context and the indication of effectiveness.

20. The device of claim 19, wherein the identifying at least one historical context of the plurality of historical contexts associated with the indication of effectiveness comprising identifying the at least one historical context of the plurality of historical contexts temporally associated with the indication of effectiveness.

21. The device of claim 1, wherein the computing apparatus is further configured to allow, following update of the adaptive model, the user to return the adaptive model to prior to being updated.

22. A method of ear-wearable hearing device comprising:
enhancing an input audio signal from a microphone using at least an adaptive model resulting in an enhanced audio signal;
providing the enhanced audio signal to a receiver;
allowing a user to adjust one or more settings;
recording an adjustment context comprising and corresponding to the adjustment of the one or more settings; and
updating the adaptive model based on the adjustment context.

23. The method of claim 22, wherein the adjustment context comprises one or more of:
at least one feature of a portion of the input audio signal corresponding to the one or more settings adjustment;
movement information corresponding to the one or more settings adjustment;
location information corresponding to the one or more settings adjustment; and
an activity classification, wherein activity classification comprises one or more of walking, exercising, playing a sport, and riding in a car.

24. The method of claim 22, wherein updating the adaptive model based on the adjustment context comprises adjusting the adaptive model in response to user initiation.

25. The method of claim 22, wherein updating the adaptive model based on the adjustment context comprises:
uploading the adjustment context an external device, wherein the external device updates the adaptive model based on the uploaded adjustment context;
receiving the updated adaptive model; and
replacing the adaptive model with the updated adaptive model.

26. The method of claim 22, wherein enhancing the input audio signal using at least the adaptive model resulting in the enhanced audio signal comprises enhancing the input audio signal using at least the adaptive model and a static model resulting in the enhanced audio signal, wherein the static model in unadjusted based on the adjustment context corresponding to the adjustment of the one or more settings.

27. The method of claim 22, wherein the method further comprises:
recording a plurality of historical contexts over a time period, each historical context of the plurality of historical contexts associated with a different time and comprising one or more of setting information, a portion of the input audio signal, movement information, and activity classification at the time of recording;
allowing the user to indicate effectiveness related to the enhancement of the input audio signal using at least the adaptive model resulting in the enhanced audio signal within the time period; and
updating the adaptive model based on at least one of the plurality of historical contexts in response to the indication of enhancement effectiveness.

28. An ear-wearable hearing device comprising:
input apparatus comprising a microphone configured to generate an input audio signal;
output apparatus comprising a receiver positionable proximate a user's ear configured to reproduce an enhanced audio signal based on the input audio signal; and
a computing apparatus comprising one or more processors operably coupled to the input apparatus and the output apparatus, wherein the computing apparatus is configured to:
enhance the input audio signal using at least an adaptive model resulting in the enhanced audio signal;
provide the enhanced audio signal to the receiver; and
update the adaptive model in response to user adjustment of one or more settings.
